(19) United States
(12) Patent Application Publication
(10) Pub. No.: US 2014/0249934 A1
(43) Pub. Date: Sep. 4, 2014

(54) COMMON POINT OF PURCHASE (CPP) DETECTION

(71) Applicant: SAS Institute Inc., Cary, NC (US)

(72) Inventors: Revathi Subramanian, Cary, NC (US); Paul C. Dulany, Cary, NC (US); Brian Lee Duke, Cary, NC (US)

(21) Appl. No.: 13/783,140

(22) Filed: Mar. 1, 2013

(51) Int. Cl. G06Q 20/40

(52) U.S. Cl. CPC G06Q 20/4016
USPC 705/14.72; 705/39; 705/44

(57) ABSTRACT

Transaction data is processed by first determining transactions in a database that are associated with a respective event that indicates a classification of interest and that share at least one common point of purchase (CPP) identifier across two or more of the determined transactions associated with the classification of interest. A set of the transactions in the database are determined, based on the CPP identifiers for transactions from as time period prior to a start time of the event and accounts associated with the event. Times of occurrence for the transactions in the set are determined, based on the CPP, and a score is generated for the received transaction for any transactions associated with at least one of the respective events and sharing at least one common CPP.

### TECHNICAL HELD

The present disclosure generally relates to computer-implemented systems and methods for processing transactions across multiple users.

### BACKGROUND

Transaction processing may result in many transactions against which data manipulations may be performed. An area of great concern to financial institutions and processors relates to fraudulent activity involving credit cards, financial accounts, debit cards, and the like. Cards and accounts that are discovered as having suffered fraudulent activity may be flagged or “black-listed” so that future transactions on such compromised accounts and cards may be prevented. Other areas of interest with respect to transaction processing relates to marketing actions based on information in the transactions.

### SUMMARY

As disclosed herein, transaction data is processed by receiving, at a computing device, a scoring request for a received transaction, and determining transactions in a database that are associated with a respective event that indicates a classification of interest and that share at least one common point of purchase (CPP) identifier across two or more of the determined transactions associated with the classification of interest. The computing device next determines a set of the transactions in the database, based on the CPP identifiers for transactions from a time period prior to a start tune of the associated respective event and accounts that are associated with the respective event; The system then determines times of occurrence for the transactions in the set, based on the CPP identifiers for transactions from the time period prior to the start time of the associated respective event and accounts that are associated with the respective event. Next, the system generates a score for the received transaction for any transactions in the database determined to be associated with at least one of the respective events and to share at least one common CPP, followed by generating information relating to the CPP identifiers for any transactions in the database determined to be associated with at least one of the respective events and to share at least one common CPP. Lastly, the processor provides the received transaction score, and the information relating to CPP identifiers.

In another aspect, transaction data is processed by identifying a common point of purchase (CPP) for multiple transactions in an offline, hatch process, and then identifying CPPs from historical transaction data, creating a list of the identified CPP entities, and creating a list of at-risk cards/accounts that have been at a CPP, but haven't yet had fraud, or purchased a given product, associated with the transaction. Processing transaction data further involves processing a received transaction, on a card/account in real time, such that as each transaction is received, it is determined if the card/account is in the created list of at-risk cards/accounts, and if it is, then information is generated on the received transaction relating to the CPP it was subject to in the created list of the identified CPP entities; and a list is created of at-risk cards/accounts that have been at a CPP, but haven't yet had fraud, or purchased a given product, associated with the transaction.

In another aspect, a computer-implemented method includes identifying a common point of purchase (CPP) for multiple transactions in an offline process, identifying CPPs from historical transaction data, and creating a list of the identified CPPs. The method involves creating a list of accounts that have been at a CPP, where the created list of accounts includes accounts that are not associated with an activity related to a purchase, and receiving transactions in real time, wherein the received transactions are associated with accounts. The method also includes determining, with a processor, whether an account associated with a received transaction is in the created list of accounts, and based upon determining that the account is in the created list of accounts, adding information for the received transaction relating to a CPP in the list of identified CPPs. The method includes creating a score related to the received transaction based upon the added information for the received transaction.

Other features may include one or more of the following features. The activity related to the purchase may include a fraudulent activity or activity associated with a purchase for a particular product. The score may relate to fraud or marketing. The score may be created in real time. The offline process may be a batch process. The list of accounts may include a list of at-risk cards or a list of at-risk accounts. The CPP may be associated with an entity, where the entity may be a merchant, a terminal, an acquirer, a payment processor, or refer to a geographic location or area.

Other features of the disclosed subject matter will be apparent from the following description of the embodiments, which illustrate, by way of example, the principles of the disclosed subject matter.

### BRIEF DESCRIPTION OF THE DRAWINGS

FIG. 1 is a block diagram representation of an example of the computer data processing system as described herein.

FIG. 2 is a flowchart representation of example operations performed in the FIG. 1 system.

FIG. 3 is a flowchart representation of operations performed in the FIG. 1 system for scoring transactions for risk of fraud, as disclosed herein.

FIG. 4 is a block diagram representation of example operations and components in the FIG. 1 system for identifying potentially fraudulent transactions.

FIG. 5 is a representation of an example of data records of financial transactions such as received in the FIG. 1 system.

FIG. 6 is a block diagram representation of an example of operations and components in the FIG. 1 system for identifying marketing opportunities.

FIG. 7 is a flowchart representation of operations performed in the FIG. 1 system to process transactions.

FIG. 8 is a schematic diagram representation of an example of a computer system for implementing the functions and operations as described herein.

### DETAILED DESCRIPTION

Stored transactions are identified in a history database of transactions across multiple entities associated with the transactions, wherein the identified stored transactions are associated with at least one co-occurrence of an event that indicates as classification of interest and share at least one common point of purchase (CPP) identifier across all the identified stored transactions for the classification of interest. In response to a scoring request for a received transaction, a transaction score is generated in response to the request. For those transactions that have not been associated with the classification of interest, but are associated with a card or account having a CPP identifier, the transaction score request response will also include information about the CPP identifier. The event may include, for example, a fraudulent transaction, and the classification of interest may include a fraudulent card or account. It should be noted that the occurrence of the event from which the classification arises may only be apparent in hindsight in some situations. For example, a purchase transaction may occur and not until weeks or even months later will it be understood that the transaction was a fraudulent transaction. The associated card or account that was involved in the fraudulent transaction will then be classified as a fraudulent card or account. In the marketing context, for example, the event may comprise a product purchase, and the classification may comprise a receptive card or account. An entity may comprise, for example, a merchant, a terminal, acquirer, payment processor, or geographic location or area, or the like.

In aspects of the disclosed subject matter, transaction data for transactions associated with purchase cards are received. In the context of fraud detection, after some period of time ranging from minutes to weeks or months, some of the transactions can be deemed to be fraudulent after conferring with the legitimate card or account holder. Based on these fraudulent transactions, a set of compromise points can be identified based on linking multiple cards or accounts to a common entity, terminal, acquirer, payment processor, or geographic area based on observing multiple fraudulent cards previously visiting the same entity. An entity may comprise, for example, a merchant, a terminal, acquirer, payment processor, or geographic location or area, or the like. These entities comprising merchants, terminals, acquirers, processors, or geographic areas may generally be referred to as common points of purchase (CPPs). A set of cards (and/or associated accounts) that visited any of the CPI's while they were vulnerable to being compromised, but that have not yet been associated with (victimized by) fraudulent activity, can be created as well. This set of cards and/or accounts that have not yet had fraud occur but were possibly compromised are referred to as cards at risk. As used herein, “account” may refer to either a card, an account, or both, unless specifically limited to one or the other.

It should be noted that more than one card may be associated with a single account, such as with corporate accounts having multiple issued cards. Transaction scoring can be performed such that a score for each received transaction can be generated using the common point of purchase (CPP) data and the cards at risk data. In this way, compromise events can be identified quickly and efficiently, thus helping to reduce financial losses from unauthorized account activity.

The identification of CPP data among fraudulent cases can aid in the identification of merchants, terminals, payment processors, geographic areas, and/or acquirers in situations where a data compromise event has taken place in the past or is currently taking place. Various embodiments of the techniques disclosed herein can use transaction data and fraud data to identify merchants, terminals, payment processors, geographic areas, and acquirers that might have possibly been compromised. This data is then used to identify cards that could have possibly been a part of a data compromise event, but have not yet suffered fraudulent activity. In a data processing system, data about suspect cards is then made available to a statistical model, for real-time scoring and for use in a rules engine, and to a case management system, for fraud alert creation and distribution.

Authorizations for credit card charges and the like are expected to be performed in real time, so a customer is not kept waiting, and therefore the identification of a compromised card and the resultant decision to decline approval for the transaction, occur in real time. The CPP-identifying process may be contained within a data processing system, such as the “SAS Enterprise Fraud Management” system from SAS Institute Inc., of Cary, N.C., which provides a system that can be updated multiple times during the day.

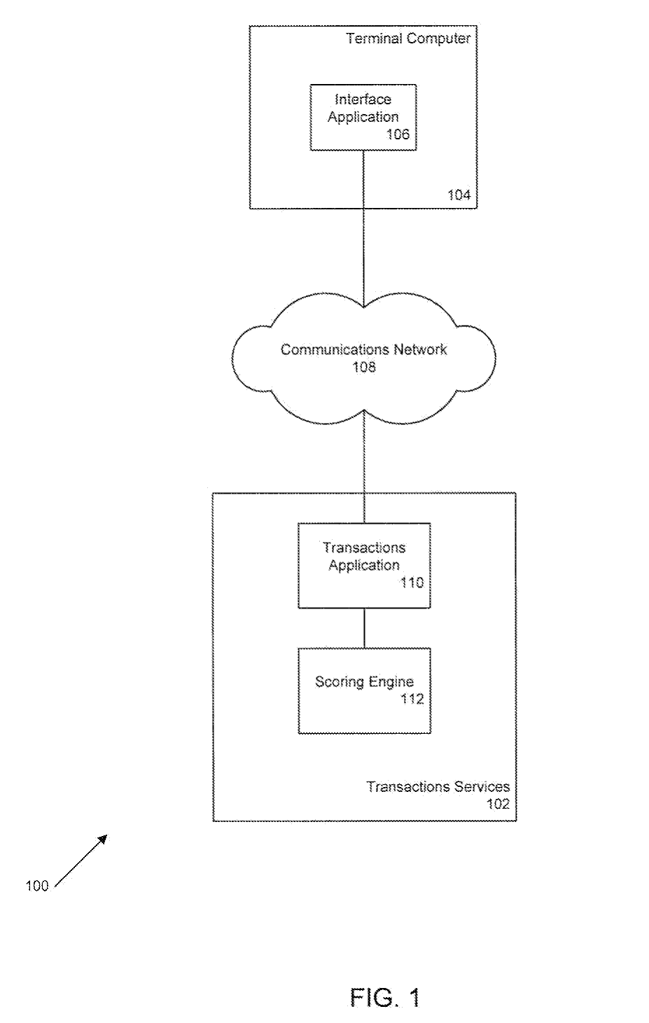

FIG. 1 is a block diagram of an example of a computer data processing system 100 that provides the features disclosed herein. FIG. 1 shows a transaction services system 102 constructed in accordance with the disclosure. A terminal computer 104 accesses the transaction services system 102 through an interface application 106 at the terminal computer. The interface application may comprise, for example, a Web browser or special purpose application installed at the terminal computer. The terminal computer 104 communicates with the transaction services system 102 over a communications network 108, such as the Internet or other data network. Alternatively, the interface application may be installed at a computer of the transaction services system 102, for direct communication.

FIG. 1 shows that the transaction services system 102 includes a transactions application 110, which receives the communications from the interface application 106. The received communications may comprise, for example, requests for determining likelihood of a compromised account and fraudulent transaction, data records of financial transactions, requests for processing data records, marketing data, and the like. The transaction services system 102 includes a scoring engine 112. The scoring engine produces one or more scores for each transaction that it receives from the transactions application 110. The score may then be used in business analytics processing to make a decision. For purposes of fraud identification and risk assessment, for example, the generated score may indicate a risk of fraud for the transaction. For purposes of marketing, for example, the generated score may indicate a product or service to be proposed. In the description herein, “transaction” will be used to refer to a data record that relates to a transaction. Those skilled in the art will understand that “transaction” in this context may refer to the data record of the transaction itself, as well as other identifying indicia, such as fraud tags, or customer identification data, indicators of special programs, and the like, and other associated data used by the system in processing the transaction and the scoring request for the transaction. Those skilled in the art will understand such details based on the context of use herein.

Processing for Detection of Common Points of Purchase (CPP) in a Transaction System

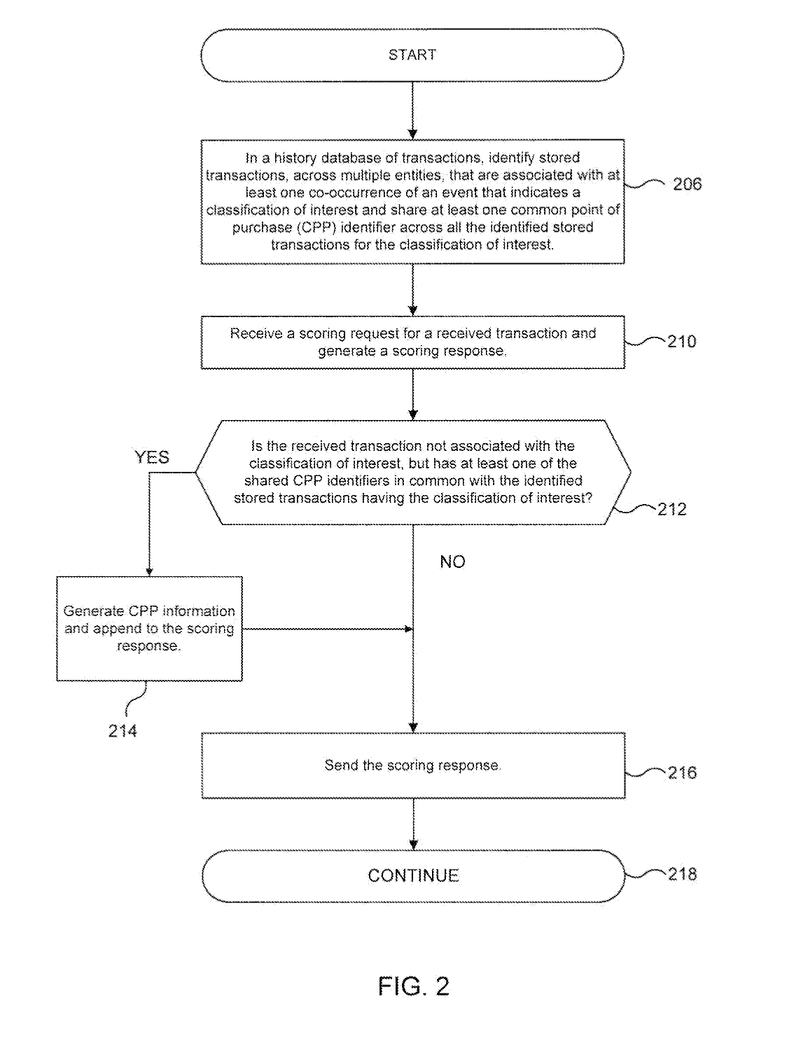

FIG. 2 is a flowchart representation of example operations performed in the FIG. 1 system 100. Beginning with the FIG. 2 box numbered 206, the operations involve a history database of transactions. The database may comprise, for example, data records relating to completed (historical) purchase transactions for a particular credit card processor or financial Institution. The operations represented by the box 206 involve identifying transactions that are associated with at least one co-occurrence of an event that indicates a classification of interest and that share at least one common point of purchase (CPP) identifier across all the identified stored transactions for the classification of interest. A co-occurrence of the event represents two occurrences of events that give rise to the classification of interest. For example, if fraud detection and decision-making are the goals of the system, then the two occurrences (co-occurrences) relate to two occurrences that are deemed to be fraudulent transactions. These transactions indicate a fraud classification for each of the two cards or accounts involved in the fraudulent transactions. If marketing decision-making is the goal, then the two occurrences may be purchase transaction events that give rise to classifying each of the associated cards or accounts as receptive cards or accounts. That is, the associated cards or accounts are involved with purchases following marketing efforts, and are given a classification that indicates they are receptive to marketing efforts. A co-occurrence of an event across multiple entities indicates that, for example, a purchase event occurred at approximately the same time at the same location with two or more different cards defining different transactions.

The system next receives a scoring request for a transaction and generates a score for the transaction, as represented by the box numbered 210. At the box numbered 212, the system determines if the received transaction is not associated with the classification of interest, but has at least one of the shared CPP identifiers in common with the stored transactions identified as having the classification of interest. If both conditions are true, an affirmative outcome at the decision box numbered 212, then CPP information is generated and appended to the scoring request response, as depicted by box 214. The system then sends the response to the scoring request, along with the appended CPP information, as represented by the box 216. System processing then continues at 218. If the conditions do not apply, meaning that the transaction was already associated with the classification of interest (such as fraud or a purchase of a target item) or has no shared CPP identifiers in common with cards or accounts associated with the classification of interest, a negative outcome at the box 212, then processing proceeds to box 216, which represents sending the response to the scoring request (i.e., the requested score for the transaction is sent in reply).

Authorization and Fraud Decision-Making Process

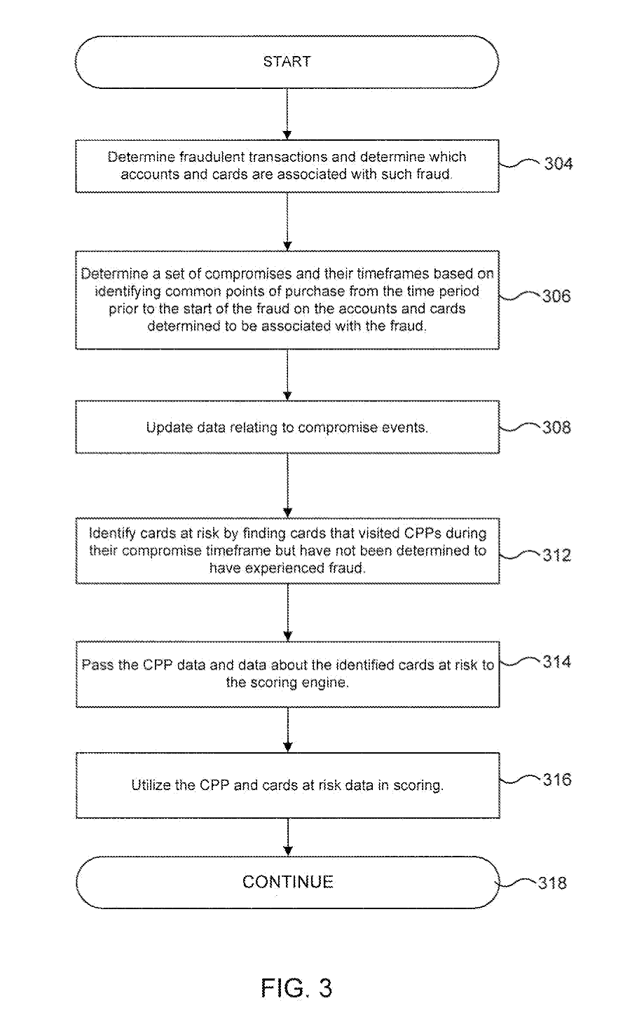

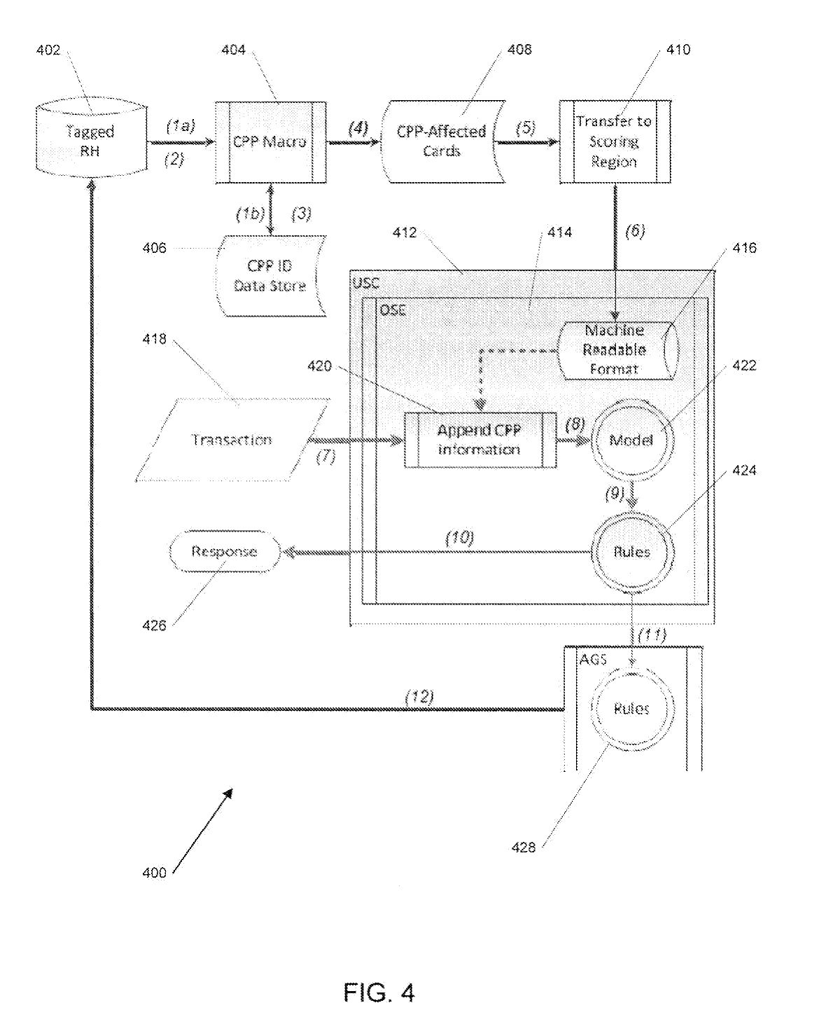

As noted above, the techniques disclosed herein can be used in fraud decision-making for transaction authorization and also in marketing decision-making. FIG. 3 is a flowchart representation of example operations performed in the FIG. 1 system 100 in performing authorization and fraud decision-making. FIG. 4 is a block diagram representation of example operations and corresponding components for identifying potentially fraudulent transactions.

FIG. 3 shows that the first operation 304 comprises determining fraudulent transactions and determining which accounts and cards are associated with such fraud. The next operation 306 determines a set of compromises and their timeframes, based on identifying common points of purchase from the time period prior to the start of the fraud on the accounts, and based on cards determined to be associated with the fraud. The next operation 308 involves updating data relating to compromise events, such as occurrences of fraud. The updating operation 308 may include updating data about previously discovered compromise events, or may include adding new data for newly discovered compromise events, or both. In any case, data about compromise events (fraud) will include data that identifies information such as the date and time-of-day range for the fraud, the number of cards involved in the fraud event and their corresponding card and account numbers, the merchant and/or geographic identifiers, and the like. Further details of this operation are described further below, in connection with FIG. 4.

The next operation 312 identifies cards at risk by finding cards that visited CPPs during their compromise timeframe, but which have not been determined to have experienced fraud. That is, for a set of cards already associated with fraud (i.e., identified as having suffered fraud), cards at risk are defined as those cards that are not currently associated with fraud, but which were used such that they have one or more CPP data in common with the set of cards already associated with fraud. At box 314, the information about such CPP data, comprising appended CPP data as described further below, is passed to a scoring engine, along with data relating to the cards at risk. The information passed along is used by the scoring engine at 316 to provide a score that reflects fraud risk, for example, indicating either a higher level of risk or a lower level of risk. A threshold of unacceptable fraud risk can be established, such that the system indicates unacceptable fraud risk for a score that exceeds the threshold value and otherwise does not.

The FIG. 3 transaction processing and fraud-identifying operations 304, 306, 308, 312, 314 could be performed according to an offline state, wherein databases are accessed and the operations indicated for 304-314 are performed. The actual scoring operation 316 is performed in real time, when the system is in an online state, in response to a request for a fraud score (indication). For example, the offline transaction processing and fraud identifying operations may be performed nightly, at the end of the business day, to ensure updated databases. During the subsequent business day, the system may respond to requests for transaction scoring by using the databases that were updated the night before, to ensure timely fraud detection with the latest data.

Further with respect to fraud decision-making. FIG. 4 is a block diagram representation of example operations and corresponding components of a system 400 for identifying potentially fraudulent transactions and for use in connection with fraud decision-making for transaction authorization.

Real-time processing is initiated in response to a received transaction and a request for scoring that transaction (indicated by the operation labeled as (7) in FIG. 4 relating to a received transaction 418). When the transaction 418 enters the system 400, it is received at a controller 412 labeled “USC” in FIG. 4 that may comprise, for example, a “Universal SAS Connector” such as available from SAS Institute Inc. The USC 412 may include a scoring processor, such as an On-Demand Scoring Engine 414 labeled “OSE.” in FIG. 4, that performs a scoring process. In the OSE 414, an operation 420 is performed to append the CPP information to the transaction 418 and provide to a model 422 in an operation labeled as (8). A model 422 then uses the transaction details, historical details from the signature(s), and the CPP information to produce a score for the transaction. The data for the transaction is then sent to a rules processor 424 in the operation (9), where an approve/decline decision is made. Finally, as response message 426 is sent from the USC 412 to the requesting system, such as a bank or other financial processing system in the operation labeled (10). These processing operations (7), (8), (9), and (10) occur in real time

After the scoring request for the received transaction 418 is performed, the transaction is sent to an Alert Generation server (AGS) 428, where case creation rules are initiated or launched that may inform the requesting party (e.g., a bank requesting the scoring) that transaction activity may be suspicious or risky, and should be confirmed. The transaction is provided to a Reporting History Database 402.

Periodically, data in the RH database 402 is consumed by the CPP Macro 404, wherein CPPs are identified and stored for future reference 406. The CPP identification process updates the CPP ID datastore 406 and creates a list of CPP affected (or at risk) cards 408. The list of CPP-affected cards 408 is then transferred 410 to the scoring engine OSE 414 to generate transaction scoring, for the next day's scoring. The transfer to the scoring engine is indicated in FIG. 4 by the operation (6). The scoring result on the CPP-affected cards is produced in a machine-readable format 416 and mar then be appended 420 to the data representing the transaction 418. The transaction, comprising the transaction data and the new appended information in the proper format 416, will be consumed in the USC 412 and from that point on, an updated list of the CPP affected cards produced from the operation 420 will be used in the USC.

The first operation in the fraud-detection process is identifying possible common points of purchase (CPP) on fraud-associated cards where there may have been a compromise event. To perform this operation, the system looks in the reporting history database 402 of transaction data for similar transactions at the same timeframe in a set time period and executes a process 404 to identify CPP data. The process is identified in FIG. 4 as “CPP Macro” and may comprise a routine or application to perform the operation. The operation of looking for similar transactions in the transaction data is indicated in FIG. 4 as the process operation (1a) and operation (2). The tagged reporting history database 402 stores transaction history data. These transactions are identified by the CPP Macro 404 as comprising similar transactions.

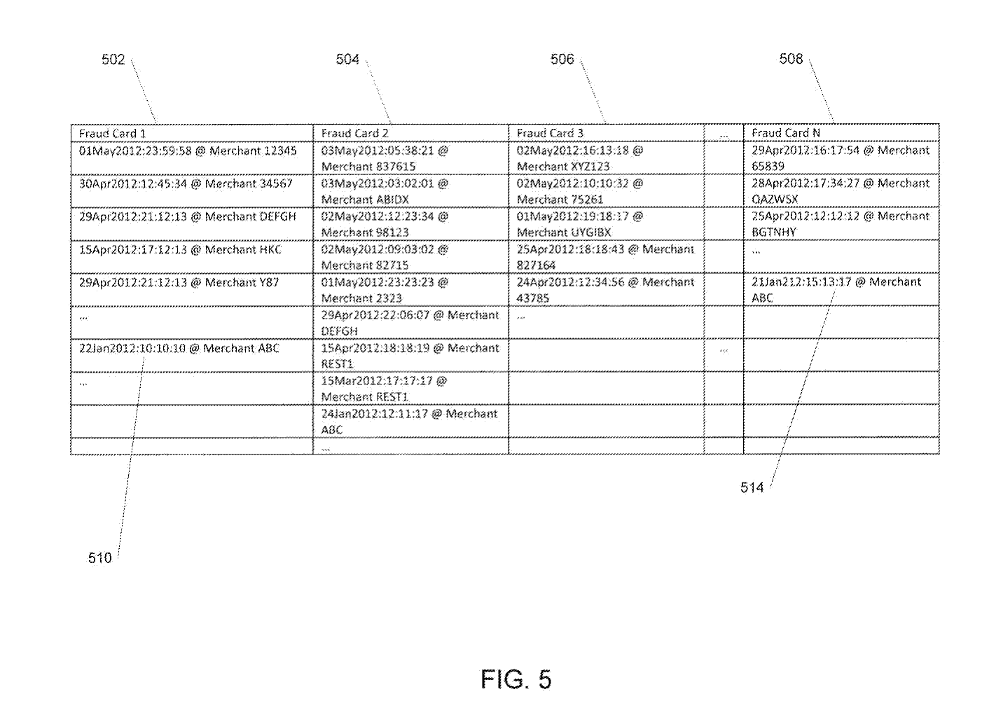

FIG. 5 is a representation 500 of example data records for multiple cards or accounts of financial transactions such as are stored in the tagged reporting history 502, to further explain processing and database update. The illustrated data 500 includes data from transactions for a plurality of cards 1, 2, 3, . . . , through N, including transactions from cards that have been identified as involved in fraudulent activity. That is, the transactions relate to cards or accounts that have been classified as fraudulent. Exemplary data for such cards is denoted in FIG. 5 as Fraud Card 1, Fraud Card 2, Fraud Card 3, and Fraud Card N indicated as 502, 504, 506, 508, respectively. More particularly, to data record in the RH database 402 (FIG. 4 may be represented as a single row for a single card of the FIG. 5 representation. Thus, if Fraud Card 1 had twenty transactions and Fraud Card 2 had thirty transactions, there would be fifty records in the RH 402 for the Fraud Card 1 and Fraud Card 2 transactions.

The first three listed transactions in FIG. 5 for Fraud Card 1 502 comprise fraudulent transactions. The first six listed transactions for Fraud Card 2 504 comprise fraudulent transactions. The first five listed transactions (i.e., all of them) for Fraud Card 3 506 comprise fraudulent transactions. The first listed transaction for Fraud Card N 508 comprises a fraudulent transaction. Three transactions 510, 512, 514 are transactions that occurred at Merchant ABC between the dates of 21st January and 24th January. Since these dates are within a relatively close timeframe (several days), and they share in common the merchant identifier and an event of interest (fraud), the system would indicate that there might have been a compromise event at Merchant ABC during this timeframe (21st January to 24th January). In this context, a compromise event refers to theft of the card and/or account details, not the theft of the monetary balance or funds from the bank or the account of the cardholder. The system attempts to identify the theft of the card and/or account details via, the CPP processing described herein. The system attempts to detect the compromise event (fraudulent activity) with the use of the stolen card details through the score that is generated. That is, the CPP Macro makes use of knowledge that one would not expect three different cards to be used at the same merchant location at approximately the same time of day. The CPP Macro is configured such that the identification of likely fraud events is in accordance with known probabilities given the number of CPP points in common. For example, the greater the number of cards involved in purchasing at the same merchant and the same time of day, the more likely fraud is present, although such may not be the case for large online merchants.

After the CPP Macro 404 process (FIG. 4) is complete, the record for Merchant ABC in the CPP ID datastore 406 may be added to or otherwise modified to indicate the suspected event of interest, that is, suspected fraud. If a new transaction (i.e., a transaction that is the subject of a scoring request) associated with a different card (i.e., a card other than 502, 504, 506, 508 in FIG. 5) indicates that the different card also shopped at Merchant ABC between 21st January and 24th January, but has not yet been associated with any fraud, then the processing of FIG. 4 will add that different card to the list of CPP-affected cards 408, because the system deems the different card to be at an elevated risk of fraud in the future. Corrective action may then be initiated, such as issuing a replacement card with a different account number.

The system operations to identify CPP transactions in the data record to be placed in the CPP datastore 406 will result in, for example, identification of a possible compromise event at Merchant ABC in a time period between roughly the transaction at 21Jan2012:15:13:17 (earliest time) under Fraud Card N and 24Jan2012:12:11:17 (latest time) under Fraud Card N. The set of possible compromise events across the cards 502, 504, 506, 508 is determined from the data record in the database 406 because, out of all the transaction data, these determined events involve the same merchant on the same day at approximately the same time of day. These transactions on these cards comprise a set of possible (new) compromises.

The set of new compromises is combined with a set of previously suspected compromise transactions from the CPP ID datastore 406 (FIG. 4). In FIG. 4, this operation is represented by the label (1b) for the operation. For example, in the operation (1b), if Merchant ABC was detected as the location of a compromise point in the previous week, with a relatively close timeframe, then the CPP ID data store 406 will be updated to indicate the possible event of interest (fraud) associated with Merchant ABC at the fraud timeframe. If Merchant ABC was not previously identified as a compromise point, then Merchant ABC would be added to the CPP ID data Store 406 as a point (location) for a potential compromise event (i.e., fraud).

After the determination of possible common points of compromise as described above, cards that have not been associated or tagged with a fraud event are extracted from the record history database 402 in an operation labeled (2) in FIG. 4 to identify how many transactions may have involved the same merchants (locations) in the same timeframes. If there are a large number of cards that shopped at one of the candidate compromise points of purchase during the compromise window without subsequent fraud, then the confidence that there is a true data compromise event (i.e., fraud) is reduced. For large merchants, such as “Amazon” or “Best Buy” or “iTunes” for example, it can be difficult to determine if there was a data compromise event, because many cards transact at these merchant retailers every day. Most apparent (suspected) compromise events at such large merchants are just a coincidence and are not true data compromise events.

A list of possible compromise events is then produced and the list of possible compromises is updated in the compromise table comprising the CPP datastore 406, an operation identified in FIG. 4 as operation (3). Additionally, a list of possibly compromised cards that have transacted at one or more of the identified compromised merchants during their respective compromise windows is generated and stored in the list of CPP-Affected cards 408, an operation identified in FIG. 4 as operation (4). That list 408, along with details about the compromises in which the card was involved, is transferred to the scoring region in an operation 410 identified in FIG. 4 as operation (5). The data regarding the list of CPP-affected cards is transferred to the USC controller 412. When the data is received in the USE scoring engine 414, the data is translated into a machine readable format 416 in an operation indicated in FIG. 4 as operation (6). As described further below, in the controller 412 and scoring engine 414, the machine readable format data 416 and is combined with received transaction data 418 to produce appended data 420 that includes the CPP information in an operation indicated in FIG. 4 as operation (7). For example, a transaction 418 may be received into the controller 412 with a request for detecting (checking for) possible fraud,

Thus, the data regarding CPP-affected cards 408 is received, by the controller 412, and transactions 418 are also received into the controller, through an operation identified in FIG. 4 as operation (7). More particularly, card transactions 418 that are in the list of suspected compromised cards 408, will be appended with the CPP data and will then be provided to the transaction model 422 in an operation identified as operation (8) to produce a fraud score, in an operation identified as operation (9). The fraud score, and optionally the appended data, is used in conjunction with a business rules set 424, where transactions can be approved or declined in real-time. Upon the completion of the scoring and approve/decline decision response output, the response 426 to the requested transaction is sent back to the requesting system, notifying the requesting system of the decision on the transaction in real time, in an operation identified as operation (10).

The transaction data and appended CPP information is sent to the AGS 428 in an operation identified as operation (11). In the AGS, cases and/or alert notifications are generated. The cases and notifications are generally handled by analysts or other financial institution personnel who contact card customers to verify proper activity, reissue new cards, and the like. After finishing in the AGS 428, the transaction data is inserted into the RU database 402 in an operation identified as operation (12), whereupon the inserted transaction data may be used in the next round of CPP detection,

Marketing Decision-Making Process

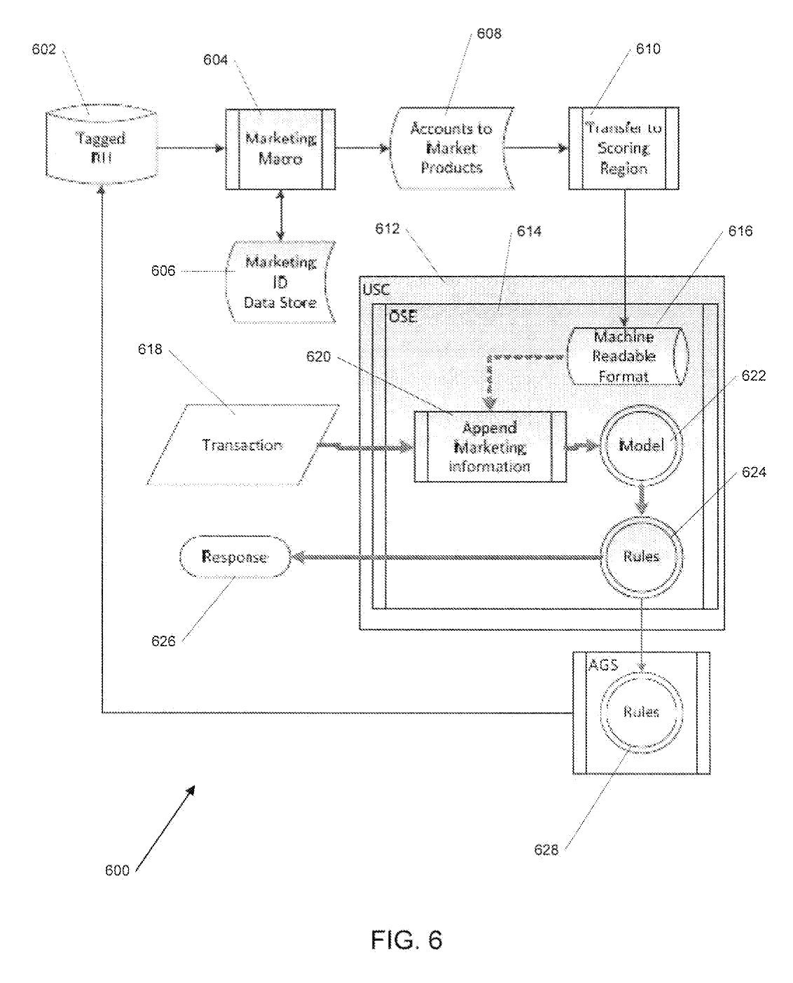

As noted above, the techniques disclosed herein can be used in fraud decision-making for transaction authorization and also in marketing decision-making. FIG. 6 is a, block diagram representation of operations and components in the FIG. 1 system 101) for identifying marketing opportunities. The operations for marketing in FIG. 6 are similar to the operations described above for fraud decision-making (FIG. 4), except that the FIG. 6 operations occur in the context of marketing decisions rather than approve/decline decisions for financial transactions. That is, the same process used for fraud decision-making can be used to process data for real-time marketing purposes back to a scoring engine. The difference in the marketing decision-making is that the data to be used is a list of cards to which marketing offers will be sent, as well as a list of offers to be made, rather than a list of CPP-affected cards.

The first operation in the marketing decision-making process of FIG. 6 is identifying cards that are to be the target of marketing efforts. The system 600 examines a record history 602 of transaction data for the cards comprising potential marketing targets and executes a process 604 to identify marketing data. The process is identified in FIG. 6 as “Marketing Macro” 604 and may comprise a routine or application to perform operations such as identifying similar products or purchase trends.

Be set of card marketing targets is combined with a set of cards involved with marketing-targeted transactions from the Marketing ID datastore 506. For example, the Marketing ID datastore could house a list of marketing opportunities, such as coupons to be redeemed, price discounts, and other offers and promotions to encourage purchasing. As another example, if it was observed that many people Who recently bought tickets to a concert later went on to purchase dinner at a location near the concert event, then a marketing strategy could be created that produces special dining offers when concert tickets are purchased. Thus, each data record in the Marketing ID datastore 606 would comprise such an offer or some other marketing strategy. As with the fraud operation described in connection with FIG. 4, the marketing function makes use of known purchase characteristics. Thus, the CPP Macro for marketing is configured such that the identification of purchase events likely to result in marketing success for additional purchases is in accordance with known probabilities given the number of CPP points in common for purchases. For example, the greater the number of cards in a card set involved in purchasing the same item at the same merchant and the same time of day, the more likely marketing efforts directed to that set of cards will result in additional purchases.

As described herein, the disclosed techniques can be used to take historical data from the reporting history database, extract information on product purchasing behavior, and push it back to corresponding marketing models so that the information can be used for generating marketing scores that are used for producing marketing offers. Customer preferences for products can drift over time, and hence the ability to extract the most recent purchase information from the extensive reporting history database and making, it available for scoring in a very timely manner can be useful. In some embodiments, another characteristic of the approach described in this disclosure is that the feedback may be implicit, in the sense that explicit feedback from customers about their purchase preferences may not be required, but implied preferences of customers can be derived from their most recent purchases.

Thus, the marketing decision-making process can review card authorizations (e.g., the recorded history) to determine co-occurrences of purchases of products. To do this, the process looks for purchases by the same card and/or account in a set time period. The list of co-occurring product purchases and accounts can be used to determine marketing targets and to transfer to the scoring engine for real-time use by the model and rules.

Some embodiments may involve the following operations.

In an offline, batch process:
(1) Use historical data to identify CPPs;
(2) Create a list of the CPP entities (A): and
(3) Create a list of “at-risk” cards/accounts (B) that have been at a CPP, but haven't yet had fraud, or purchased a given product, etc.

Then, in real time:
(1) As each transaction arrives, check to see if the card/account is in (B) above, and if it is, then fill out information on the transaction relating to the CPP in (A) to which it was subject; and
(2) Use the disclosed technology in addition to the data added to the transaction from the CPP process (if any was added) to create a score for fraud, marketing, and the like, as desired.

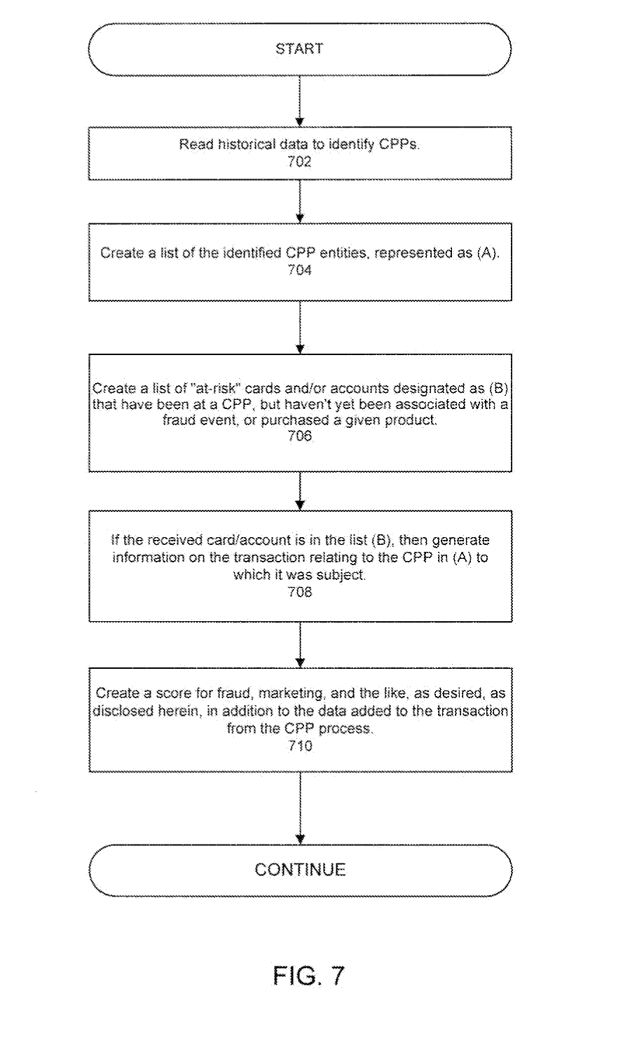

FIG. 7 is a flowchart representation of the operations set forth immediately above, performed in the FIG. 1 system, to process transactions as noted herein. The initial operations in the processing relate to an offline batch process, in which a processor of the system first reads historical data to identify CPPs, as indicated at the box 702. The historical data relates to data previously recorded, or previously received and stored. The next operation, at box 704, indicates that the processor creates a list of the identified CPP entities, represented as (A). The following operation at 706 comprises the processor creating a list of “at-risk” cards and/or accounts designated as (LI) that have been at a CPP, but haven't yet been associated with a fraud event, or purchased a given product, or the like.

The next series of operations is performed in real time, so that each operation is performed on a received transaction data before the next operation is begun. In the first real-time operation, as each transaction arrives, the processor checks to see if the received card/account is in the list (B) above. If the received transaction is in (B), at box 708, the processor generates information on the transaction relating to the CPP in (A) to which it was subject. The next operation, at box 710, is to create as score for fraud, marketing, and the like, as desired, as disclosed herein, in addition to the data added to the transaction from the CPP process (if any was added).

Exemplary Hardware System

The systems and methods described above may be implemented in a number of ways. One such implementation includes computer devices having various electronic components. For example, components of the system in FIG. 1 may, individually or collectively, be implemented with devices having one or more Application Specific Integrated Circuits (ASICs) adapted to perform some or all of the applicable functions in hardware. Alternatively, the functions may be performed by one or more other processing units for cores), on one or more integrated circuits or processors in programmed computers. In other embodiments, other types of integrated circuits may be used (e.g. Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific computer processors.

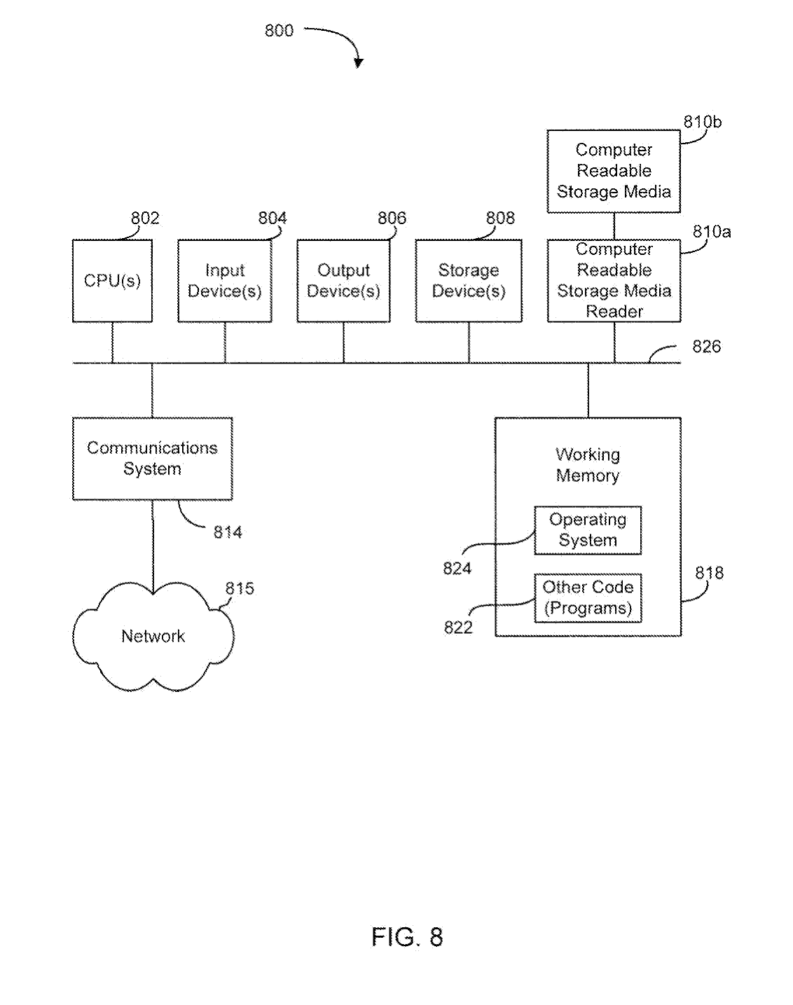

FIG. 8 provides a block diagram of a computing device also referred to as a computer data processing system 800 for implementing certain functions and operations as described herein. The computer data processing system 800 may implement, for example, any one or all of the transaction services computer 102, user computer 104, transactions application 110, reporting history database 112, scoring engine 114, and CPP data database 116 illustrated in FIG. 1. It should be noted that FIG. 8 is meant only to provide a generalized illustration of various components, any or all of which may be utilized as appropriate. FIG. 6, for example, broadly illustrates how individual system elements may be implemented in a relatively separated or relatively more integrated manner,

The system 800 is shown comprising hardware elements that can be electrically coupled via a system bus 826 (or may otherwise be in communication, as appropriate). The hardware elements can include one or more central processor units (CPUs) 802, including without limitation one or more general-purpose processors and/or one or more special-purpose processors (such as communication processing chips, graphics acceleration chips, and/or the like); one or more input devices 804, that can include, without limitation, a mouse, a keyboard, and/or the like; and one or more output devices 806, which can include without limitation a display device, a printer, audio device, and/or the like.

The system 800 may further include (and/or be in communication with) one or more storage devices 808, which can comprise, without limitation, local and/or network accessible storage and/or can include, without limitation, a disk drive, a drive array, an optical storage device, solid-state storage device such as a random access memory (“RAM”), and/or a read-only memory (“ROM”), which can be programmable, flash-updateable, and/or the like. The system 800 might also include a communications subsystem 814, which can include without limitation a modem, a network card (wireless or wired), an infra-red communication device, a wireless communication device and/or chipset (such as a Bluetooth device, an 802.11 device, a WiFi device, a WiMax device, cellular communication facilities, etc.), and/or the like. The communications subsystem 814 may permit data to be exchanged with a network 815, and/or any other devices described herein. The network 815 may comprise a local area network (LAN) or a network such as the Internet, or a combination. In many embodiments, the computational system 800 will further include a working memory 818, which can include a RAM or ROM device, as described above.

The system 800 also may comprise software elements, shown as being currently located within the working memory 818, including an operating system 824 and/or other code, such as one or more application programs 822, which may comprise computer programs performing tasks and operations described above, and/or may be designed to implement methods in accordance with the disclosed subject matter and/or configure systems in accordance with the disclosed subject matter, as described herein. Merely by way of example, one or more procedures described with respect to the method(s) discussed above might be implemented as code and/or instructions executable by as computer (and/or a processor within a computer). In one embodiment, the data generating and presenting operations are implemented as application programs 822. In the description herein, references to “interface” and “processor” and “application” should be understood as referring to hardware, software, and combinations of the two, either as independent components (hardware, software, and/or both) for each interface, processor, or application, or as integrated components combined with one or more other components.

A set of these instructions and/or code may be stored on a computer readable storage medium 810b. In some embodiments, the computer readable storage medium 810b may comprise the storage device(s) 808 described above. In other embodiments, the computer readable storage medium 810b might be incorporated within the computer system 800. In still other embodiments, the computer readable storage medium 810b might be separate from the computer system (i.e. it may be a removable readable medium, such as a compact disc, etc.), and or might be provided in an installation package, such that the storage medium can be used to program a general purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.), then takes the form of executable code. In these embodiments, the computer readable storage medium 810b may be read by a computer readable storage media reader 810a,

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one embodiment, local and remote computer systems (such as the computer data processing system 800) are utilized to perform methods of the disclosed subject matter. According to a set of embodiments, some or all of the procedures of such methods are performed by the system 800 in response to the processor 802 executing one or more sequences of one or more instructions (which might be incorporated into the operating system 824 and/or other code, such as an application program 822) contained in the working memory 818. Such instructions may be read into the working memory 818 from another machine-readable medium, such as one or more of the storage device(s) 808 (or 810). Merely by way of example, execution of the sequences of instructions contained in the working memory 818 might cause the processor(s) 802 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 800, various machine-readable media might be involved in providing instructions code to processor(s) 802 for execution and/or might be used to store and/or carry such instructions/code (e.g., as transmissions). In many implementations, a computer readable medium is a physical and/or tangible storage medium. Such a medium may take many forms, including but not limited to, volatile and non-volatile media. Non-volatile computer-readable media includes, for example, optical or magnetic disks, such as the storage device(s) (808 or 810). Volatile computer-readable media includes, without limitation, dynamic memory, such as the working memory 818. In some implementation, data may be carried over transmission media. Transmission media includes coaxial cables, copper wire, and fiber optics, including the wires that comprise the bus 826, as well as the various components of the communication subsystem 814 (and/or the media by which the communications subsystem 814 provides communication with other devices). Hence, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a PLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 802 for execution. Merely by way of example, the instructions may initially be carried on a magnetic disk and/or optical disc of a remote computer. A remote computer might load the instructions into its dynamic memory and send the instructions over a transmission medium to be received and/or executed by the computational system 800.

The communications subsystem 814 (and/or components thereof) generally will receive the transmission, and the bus 826 then might carry the transmissions (and/or the data, instructions, etc. carried by the transmissions) to the working memory 818, from which the processor(s) 802 retrieves and executes the instructions. The instructions received by the working memory 818 may optionally be stored on a storage device 808 either before or after execution by the processor(s) 802.

It will be appreciated that many processing capabilities in addition to those described are possible, without departing from the teachings according to the disclosed subject matter. Further, it should be noted that the methods, systems, and devices discussed above are intended merely to be examples. Various embodiments may omit, substitute, or add various procedures or components as appropriate. For example, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the disclosed subject matter.

Specific details are given in the description to provide a thorough understanding of the embodiments. However, it will be understood by one of ordinary skill in the art that the embodiments may be practiced without these specific details.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional operations not included in the figures.

Other variations are within the spirit of the present disclosed subject matter. Thus, while the disclosed subject matter is susceptible to various modifications and alternative constructions, certain illustrated embodiments thereof are shown in the drawings and have been described above in detail. It should be understood, however, that there is no intention to limit the disclosed subject matter to the specific form or forms disclosed, but on the contrary, the intention is to cover all modifications, alternative constructions, and equivalents falling within the spirit and scope of the disclosed subject matter, as defined in the appended claims.

Many of the methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosed subject matter and does not pose a limitation on the scope of the disclosed subject matter unless otherwise claimed.

Thus, particular embodiments have been described. Other embodiments are within the scope of the following claims. For example, the actions recited in the claims can be performed in a different order and still achieve desirable results.

What we claim is:

1. A computer implemented method, comprising:
receiving, at a computing device, a scoring request for a received transaction;
determining transactions in a database that are associated with a respective event that indicates a classification of interest and that share at least one common point of purchase (CPP) identifier across two or more of the determined transactions associated with the classification of interest;
determining a set of the transactions in the database, based on the CPP identifiers for transactions from a time period prior to a start time of the associated respective event and accounts that are associated with the respective event;
determining times of occurrence for the transactions in the set, based on the CPP identifiers for transactions front the time period prior to the start time of the associated respective event and accounts that are associated with the respective event;
generating a score for the received transaction for am transactions in the database determined to be associated with at least one of the respective events and to share at least one common CPP;
generating information relating to the CPP identifiers for any transactions in the database determined to be associated with at least one of the respective events and to share at least one common CPP; and
providing the score for the received transaction and the information relating to CPP identifiers.

2. The method of claim 1, wherein the classification of interest comprises a fraud classification.

3. The method of claim 2, further comprising:
updating data in the database relating to the determined set of transactions;
determining accounts that visited entities among the CPP identifiers during the time period that are not associated with one of the respective events that indicates a fraud classification, wherein the determined accounts comprise accounts at risk;
providing CPP information comprising the determined set of transactions, times of occurrence for the set of transactions, and data relating to the accounts at risk, to as scoring engine that performs a scoring process and generates the score for the received transaction; and
utilizing the CPP information in the scoring process.

4. The method of claim 3, wherein each of the determined accounts relates to as unique card number associated with the account.

5. The method of claim 3, wherein each of the accounts relates to more than one card number, each of which is associated with the account.

6. The method of claim 1, wherein the event that indicates a classification of interest comprises a fraudulent purchase event.

7. The method of claim 1, wherein the event that indicates a classification of interest comprises a purchase event in response to a marketing effort.

8. The method of claim 1, wherein the CPP identifier of a transaction comprises at least one of the set including an entity associated with one of the transactions, day of transaction, time of transaction, an entity category, and an entity location.

9. The method of claim 1, further comprising:
determining whether to approve or decline the received transaction, wherein determining is performed in real time.

10. The method of claim 1, further comprising:
performing a scoring process;
generating a fraud notification when the scoring process is indicative of fraud.

11. The method of claim 1, further comprising:
performing a scoring process; and
producing a real time marketing offer when the scoring process is indicative of a high likelihood of response.

12. The method of claim 1, further comprising:
performing a scoring process, wherein performing the scoring process includes using signature data, and wherein the signature data includes historical data.

13. A system comprising:
one or more processors; and
one or more non-transitory computer-readable storage mediums containing instructions configured to cause the one or more processors to perform operations including:
receiving a scoring request for a received transaction;
determining transactions in a database that are associated with a respective event that indicates a classification of interest and that share at least one common point of purchase (CPP) identifier across two or more of the determined transactions associated with the classification of interest;
determining a set of the transactions in the database, based on the CPP identifiers for transactions from a time period prior to a start time of the associated respective event and accounts that are associated with the respective event;
determining times of occurrence for the transactions in the set, based on the CPP identifiers for transactions from the time period prior to the start time of the associated respective event and accounts that are associated with the respective event;
generating a score for the received transaction for any transactions in the database determined to be associated with at least one of the respective events and to share at least one common CPP;
generating information relating to the CPP identifiers for any transactions in the database determined to be associated with at least one of the respective events and to share at least one common CPP; and
providing the score for the received transaction and the information relating to CPP identifiers.

14. The system of claim 13, wherein the classification of interest comprises a fraud classification.

15. The system of claim 14, further comprising instructions configured to cause the one or more processors to perform operations including:
updating data in the database relating to the determined set of transactions;
determining accounts that visited entities among the CPP identifiers during the time period that are not associated with one of the respective events that indicates a fraud classification, wherein the determined accounts comprise accounts at risk;
providing CPP information comprising the determined set of transactions, times of occurrence for the set of transactions, and data relating to the accounts at risk, to a scoring engine that performs a scoring process and generates the score for the received transaction; and
utilizing the CPP information in the scoring process.

16. The system of claim 13, wherein each of the determined accounts at risk relates to a unique card number associated with the account.

17. The system of claim 13, wherein each of the accounts at risk relates to more than one card number, each of which is associated with the account.

18. The system of claim 13, wherein the event that indicates a classification of interest comprises a fraudulent purchase event.

19. The system of claim 13, wherein the event that indicates a classification of interest comprises a purchase event in response to a marketing effort.

20. The system of claim 13, wherein the CPP identifier of a transaction comprises at least one of the set including an entity associated with one of the transactions, day of transaction, time of transaction, an entity category, and an entity location.

21. The system of claim 13, further comprising:
determining whether to approve or decline the received transaction, wherein determining is performed in real time.

22. The system of claim 13, further comprising instructions configured to cause the one or more processors to perform operations including:
performing a scoring process;
generating a fraud notification when the scoring process is indicative of fraud.

23. The system of claim 13, further comprising instructions configured to cause the one or more processors to perform operations including:
performing a scoring process;
producing a real time marketing offer when the scoring process is indicative of a high likelihood of success.

24. The system of claim 13, further comprising:
performing a scoring process, wherein performing the scoring process includes using signature data, and wherein the signature data includes historical data.

25. A computer program product, tangibly embodied in a non-transitory machine-readable storage medium, including instructions configured to cause a data processing system to:
receive, at a computing device, a scoring request for a received transaction;
determine transactions in a database that are associated with a respective event that indicates a classification of interest and that share at least one common point of purchase (CPP) identifier across two or more of the determined transactions associated with the classification of interest;
determine a set of the transactions in the database, based on the CPP identifiers for transactions from a time period prior to a start time of the associated respective event and accounts that are associated with the respective event;
determine times of occurrence for the transactions in the set, based on the CPP identifiers for transactions from the time period prior to the start time of the associated respective event and accounts that are associated with the respective event;
generate a score for the received transaction for any transactions in the database determined to be associated with at least one of the respective events and to share at least one common CPP;
generate information relating to the CPP identifiers for any transactions in the database determined to be associated with at least one of the respective events and to share at least one common CPP; and
provide the score for the received transaction and the information relating to CPP identifiers.

26. The computer program product of claim 25, wherein the classification of interest comprises a fraud classification.

27. The computer program product of claim 26, further comprising instructions configured to cause the data processing system to:
update data in the database relating to the determined set of transactions;
determine accounts that visited entities among the CPP identifiers during the time period that are not associated with one of the respective events that indicates a fraud classification, wherein the determined accounts comprise accounts at risk;
provide CPP information comprising the determined set of transactions, times of occurrence for the set of transactions, and data relating to the accounts at risk, to a scoring engine that performs a scoring process and generates the score for the received transaction; and
utilize the CPP information in the scoring process.

28. The computer program product of claim 27, wherein each of the determined accounts relates to a unique card number associated with the account.

29. The computer program product of claim 27, wherein each of the accounts relates to more than one card number, each of which is associated with the account.

30. The computer program product of claim 25, wherein the event that indicates a classification of interest comprises a fraudulent purchase event.

31. The computer program product of claim 25, wherein the event that indicates a classification of interest comprises a purchase event in response to a marketing effort.

32. The computer program product of claim 25, wherein the CPP identifier of a transaction comprises at least one of the set including an entity associated with one of the transactions, day of transaction, time of transaction, an entity category, and an entity location.

33. The computer program product of claim 25, further comprising instructions configured to cause the data processing, system to:
determine whether to approve or decline the received transaction, wherein determining is performed in real time.

34. The computer program product of claim 25, further comprising instructions configured to cause the data processing system to:
perform a scoring process;
generate a fraud notification when the scoring process is indicative of fraud.

35. The computer program product of claim 25, further comprising instructions configured to cause the data processing system to:
perform a scoring process; and
produce a real time marketing offer when the scoring process is indicative of a high likelihood of response.

36. The computer program product of claim 25, further comprising instructions configured to cause the data processing system to:
perform a scoring process, wherein performing the scoring process includes using signature data, and wherein the signature data includes historical data.

37. A computer implemented method, comprising:
identifying a common point of purchase (CPP) for multiple transitions in an offline, hatch process;
identifying CPPs from historical transaction data;
creating a list of the identified CPPs; and
creating a list of at-risk cards or accounts that have been at a CPP but have not had fraud, or purchased a given product, associated with a transaction;
processing a received transaction on a card or account in real time at a processor, such that as each transaction is received, the processor determines whether the card or the account is in the created list of at-risk cards or accounts;
responsive to determining that the card or the account is in the created list of at-risk cards or accounts, generating information on the received transaction relating to the CPP it was subject to in the created list of the identified CPP; and
creating a list of at-risk cards or accounts that have been at a CPP, but have not had fraud, or purchased a given product, associated with the transaction.

38. A computer-implemented method comprising:
identifying a common point of purchase (CPP) for multiple transactions in an offline process;
identifying CPPs from historical transaction data;
creating a list of the identified CPPs;
creating a list of accounts that have been at a CPP, wherein the created ist of accounts includes accounts that are not associated with an activity related to a purchase;
receiving transactions in real time, wherein the received transactions are associated counts;
determining, with a processor, whether an account associated with a received transaction is in the created list of accounts;
based upon determining that the account is in the created list of accounts, adding information for the received transaction relating to a CPP in the list of identified CPPs; and
creating a score related to the received transaction based upon the added information for the received transaction.

39. The computer-implemented method of claim 38, wherein the activity related to the purchase includes a fraudulent activity or activity associated with a purchase for a particular product.

40. The computer-implemented method of claim 38, wherein the score relates to fraud.

41. The computer-implemented method of claim 38, wherein the score relates to marketing.

42. The computer-implemented method of claim 38, wherein the score is created in real time.

43. The computer-implemented method of claim 38, wherein the offline process is a batch process.

44. The computer-implemented method of claim 38, wherein the list of accounts comprises a list of at-risk cards or a list of at-risk accounts.

45. The computer-implemented method of claim 38, wherein the CPP is associated with an entity, wherein the entity comprises a merchant, a terminal, an acquirer, a payment processor, or refer to a geographic location or area.
